(19) United States
(12) Patent Application Publication
(10) Pub. No.: US 2013/0291607 A1
(43) Pub. Date: Nov. 7, 2013

(54) BIO SUPER VEGETABLE GARDENS (BSVG)

(71) Applicant: Rawya Lofty Mansour, Monaco (MC)

(72) Inventor: Rawya Lofty Mansour, Monaco (MC)

(21) Appl. No.: 13/979,890

(22) PCT Filed: Mar. 22, 2011
(86) PCT No.: PCT/EG2011/000004

§ 371 Date: Jul. 16, 2013

(30) Foreign Application Priority Data
Jan. 23, 2011 (EG) 2011010144

(51) Int. Cl. C05D 9/00

(52) U.S. Cl. CPC C05D 9/00
USPC 71/6

(57) ABSTRACT

The Bio Super Vegetable Gardens (BSVG) obtains the highest bio-productivity of some cash vegetables crops per unit area by planting them utilizing a friendly environment technology, through the addition of organic waste to the soil, e.g. plant wastes (rice straw and compost) and animal wastes (chicken manure), Bentonite or Biochar, Mixture of natural minerals, biopolymers and efficient micro-organisms (EM). Thus, improving its chemical, physical and biological soil properties and hence increasing its productivity. Furthermore, the soil is surrounded with plastic sheet to keep essential nutrients and water from leakage. After that, the BSVG are cultivated with 4 rotation cycle by different kinds of vegetables. A 40% higher yield output and a savings of 60% of irrigation water is achieved compared to traditional untreated soils.

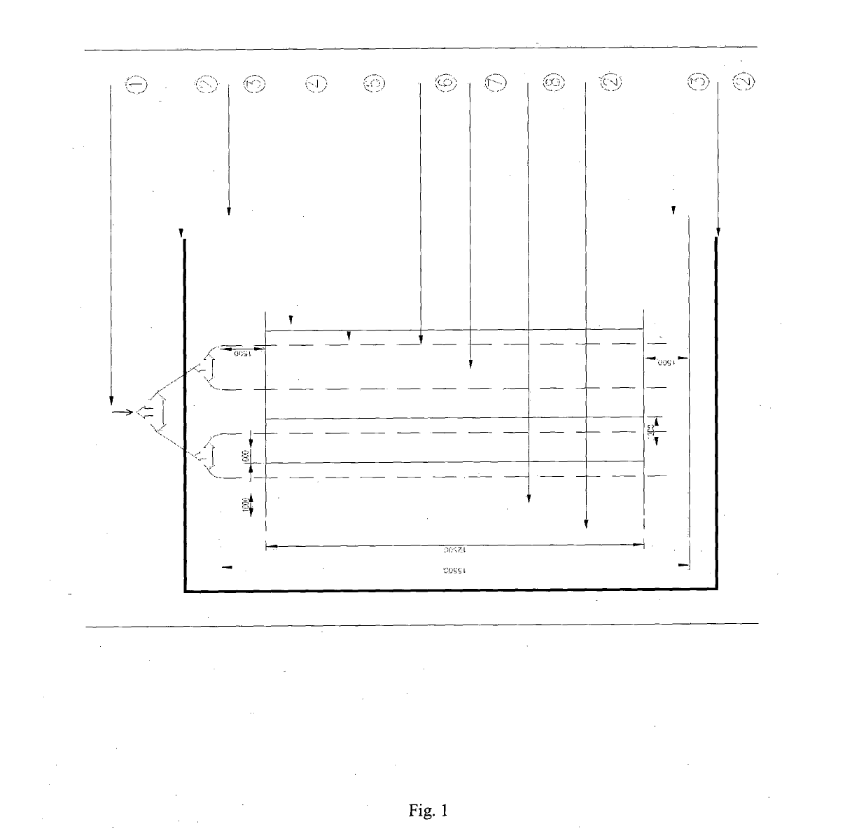

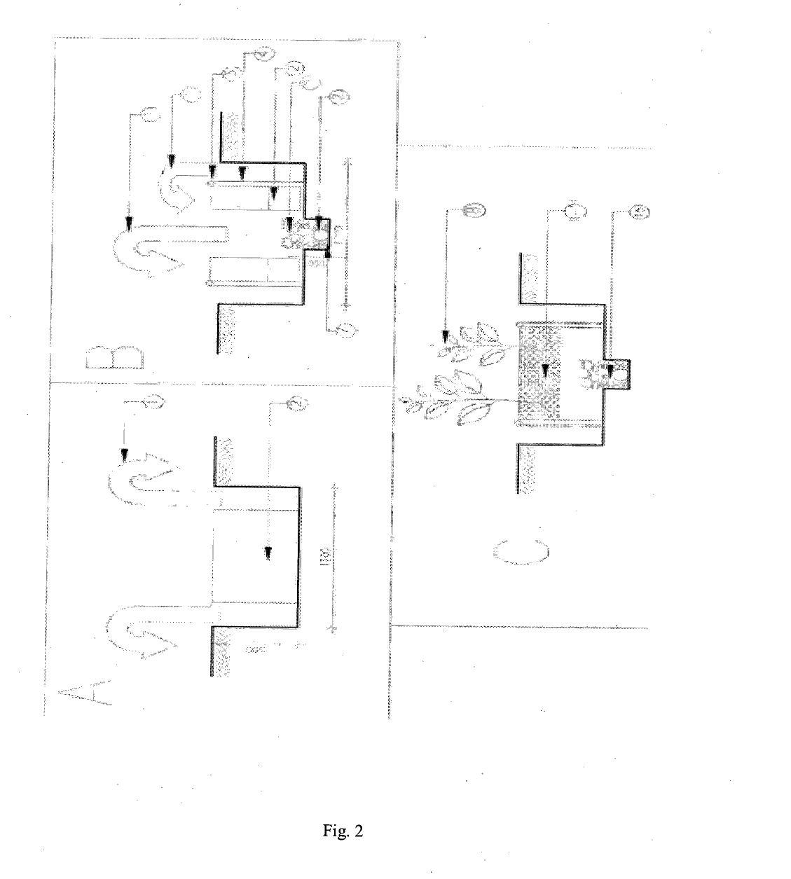

### TECHNICAL FIELD

The objective of this invention in the field of agriculture for the production of vegetables by adding vital organic wastes Plant and animal working to increase the productivity of the crop at rates of up to 40%, and also working to provide irrigation water at rates up to 60%

### BACKGROUND ART

The Arab Republic of Egypt, like most Arab countries, faces currently and in the future a lot of food problems due to the lack of water and excessive desert lands. Therefore, Egypt is adopting a policy for horizontal expansion by reclaiming and cultivating desert lands on both sides of the Nile Valley and the Delta, which are mostly low-level sandy with low productivity due to low content of organic matter, lower than 0.1%. In addition to the inability of these lands to retain irrigation water due to the coarse texture of the sand plus the inability to supply the plants with the necessary nutritional elements which are seeped into the ground water and consequently causing great environmental and health hazards.

Many researchers try to avoid such resistance which ultimately results in the reduction of land productivity and also try to produce various varieties of organically-produced vegetables in sufficient amounts without any health hazards by means of improving the physical, chemical and biological characteristics of this type of lands—taking into consideration the preservation of the environment and non-employment of any chemicals or pesticides posing health hazards. A lot of researches indicate the positive impact of the soil additives of vegetable waste such as rice straw, corn wood and palm branches, etc., or after transformation to compost as well as the organic fertilizers and their high positive impact on the natural, chemical and biological characteristics of these kinds of lands. However, despite the foregoing, such organic additives are not sufficient enough to increase the output of vegetables planted in these sandy lands.

### DISCLOSURE OF THE INVENTION

(Comprises the operation method in cases of the equipment, tools and devices or chemical preparation in cases of chemical and agricultural substances, laboratory tests, and side effects. Schedules and clarification diagrams are attached, if any, in separate sheets, following the new elements that require protection, provided the diagrams are numbered and placed in a vertical position with no explanatory data thereon. The parts of the drawings are defined only by numbers which are described and explained within the detailed description)

The idea of the invention “Bio-super organic vegetable gardens” is mainly based on increasing the biological growth of the soil by organic additives containing great number of microorganisms and relying on natural materials for increasing the productivity capacity of these lands. The idea also depends on drip-irrigation as a main technique for economizing on the amount of water used and avoid contamination of ground water by adding a combination of natural materials for improving the physical, chemical and biological characteristic of the desert lands. These materials are:

(Compost+organic fertilizer+rice straw)+bentonite or biochar+natural mixture mineral fertilizers+EM+bio-polymer

1. Compost+Organic Fertilizer+Rice Straw:

The newly reclaimed lands in the Arab Republic of Egypt are characterized by the excessive sandy texture and low content of organic matter which are considered two major factors in determining the soil ability to retain water and ability to supply plants with the nutritional elements necessary for their existence. Therefore, the addition of some natural organic compounds derived from some plant and animal waste is considered an essential and major element for increasing the fertility of the sandy soil and, hence, increase its productive capacity as a result of increasing the soil content of organic matter that lead to increasing the soil ability to retain irrigation water and nutritional elements necessary for the plant due to increasing the cationic interchange capacity of such organic materials compared to the sand land of low cationic interchange capacity which cannot retain water or the essential nutritional elements.

Moreover, the addition of organic waste to the sandy soil reduces the soil acidity (pH) as it is decomposed in the soil and produces some organic acids and, therefore, helps increase the availability of the necessary nutritional materials often found in sandy lands but difficult for plants to attain.

2. Bentonite:

Bentonite is a certain type of clay mineral found abundantly in Egypt in the form of “clay”. This mineral is characterized by a high Cation Exchange Capacity (CEC) compared to the clay mineral found in excess in sandy lands; it is a clay mineral of Kaolinite of low cationic exchange capacity. The addition of bentonite to the sandy lands is considered highly efficient in increasing the productivity of these lands as an active and cheap way for improving the natural, chemical and biological characteristics of this type of land.

3. Biochar:

A natural raw material found in some Latin American countries and it can be locally processed by treatment of vegetable waste under high temperature and reduced conditions.

4. Natural Mixture Mineral Fertilizers:

A natural mixture of two different combinations of natural minerals, not chemically processed, that contains all nutrition elements required by plants (16 in number) and essential for growth. Microorganisms available in EM compounds are added to transform these nutrient elements to a form suitable for the nutrition of plants.

5. EM (Efficient Microorganisms):

Sandy lands are characterized by a low total number of microorganisms, particularly the useful ones which trigger the decomposition of organic matter added and, hence, increase soil fertility as a result of increasing the nutrition elements in soil and ultimately improve soil productivity. Efficient Microorganisms (EM) are combinations of microorganisms (photosynthesis bacteria, lactic acid bacteria, some enzymes, materials, remains of decomposed molasses).

6. Bokashi:

Bokashi is a Japanese word meaning an organic matter fermented by means of efficient microorganisms (EM) and consists mainly of 3 components (volume-based): rice straw (1 gm.), soil (1 gm.), animal biomass (2 gm.) such as organic fertilizer.

The mixture is sealed from air after adding at least 40% moisture and is kept for not less than 40 to 60 days. After full fermentation that is manifested by a uniform texture similar to compost, Bokashi is added to the soil at a ratio of 2 tons per feddan and sometimes the ratio is as much as 6 tons per feddan.

If bokashi is used prematurely, one ton per feddan shall be added together with 1 ton (per feddan) of organic fertilizer as long as the C/N ratio is not stable.

Other organic varieties may be used as a substitute for rice straw, provided they are ground into particles of not more than 5-10 mm. in size.

7. Organic Polymer:

Given the fact that sandy lands are characterized by poor ability to retain water, adding natural matter high in water absorption, such as Bio-Polymer, which is a natural material of plant and animal waste that can be used in organic agriculture. Bio-polymers increases soil capability to retain water due to increasing the absorption capacity of theses materials to water in comparison to sandy lands where water loss may be more than 80%.

8. (PVC):

A certain type of plastic (PVC) is used at a depth of 45 cm to keep water from draining out and make maximum use of every drop of water added to the soil.

9. Poly Propylene (White Plastic Sheets):

A certain type of white cover made of polypropylene is used to maintain the relative humidity around the seedlings in an optimum condition and to protect them against insect or disease infection.

The process of making “Bio-super Organic Gardens” of this invention can be divided into 8 stages varying according to the farmers expertise. Therefore, the best thing to be done is to train farmers on this invention before implementing. The steps can be summed up as follows:

1. Garden Lay Out:

The garden which contains 4 plots (trenches) is planned so that the width of the plot is 1.2 m. wide and length 12.5 m. and a total area of 15 square meters. These plots are separated by a path of not less 60 m wide.

2. Digging a Trench in the Circumference of that Plot to Place Side Barriers:

After lay out, the soil is brought out from inside the plot from all sides (1.2×12.5×0.45 m.) at a width of 20 cm. to the outside to place a water-proof plastic black sheet (PVC) in the trench, using a shovel for sandy-texture lands and fork for lands of silt texture.

3. Insulating the Plot Soil from the Rest with Black PVC Insulator:

After placing the double black plastic PVC insulator at a depth of 45 cm. in at sides of the plot and placing strong wooden struts 6 m long inside the black PVC to support the plastic sheet and prevent from falling and then fixing the black PVC by refilling the trench again with soil.

4. Drain Trench:

To ascertain good drainage, a trench is dug in the center of each plot, 50 cm. deep and 30 cm. wide, by removing the soil from the center out to the sides of the plot. A plastic drainage pipe, 2 inches in diameter with holes to collect drainage water is placed tilted so that the drain water is directed outside the plot. The drain pipe is covered with some of the excess waste that is available on the farm such as rice straw, palm branches, plant branches, etc. to provide a suitable medium for draining the excess agriculture drainage water. Thereafter, it is very important to return all soil previously dug out back into the plot once more.

5. Making a Good Bed for the Plants:

To have a good bed made for cultivating vegetables and provide the plants with the essential elements to complete its life cycle, the following materials are spread over the surface on an area of 15 m for every plot.
From 30 to 40 kg. compost, produced by the fermentation of waste plants.
From 20 to 30 kg. of chicken manure, as an organic manure from an animal source.
From 20 to 25 kg. of rice straw.
From 25 to 40 kg. of Bentonite or 15 to 30 kg. of biochar.
From 3 to 5 kg. of Bentonite or 15 to 30 kg. of Biochar.
From 3 to 5 kg. of a mixture of natural mineral fertilizers containing all major and minor nutritional elements necessary for the production of vegetables.
A water-absorbent material “Bio-Polymer”, at a rate of 2.55 to 3.22 kg.
Addition of EM mixture to irrigation water, at a rate of 2 to 4 liter per feddan or any additives by means of spraying the leaves of these vegetable during different plant stages and which is a combination of efficient microorganisms highly capable of increasing the total number of such microorganisms and, hence, increasing the decomposition of organic matter and increasing the availability of nutrition elements and transforming it into a suitable substance for vegetable nutrition.

Then, the materials are mixed together as well as with the soil at a depth of 25-30 cm. using a shovel or a hoe. After that, the soil is spread and leveled.

6. Irrigation:

This technique basically depends on irrigation by dripping in order to save as much water as possible after that the irrigation pipes are laid in the center of the plot and the distance between the drippers is determined based on the type of vegetable planted.

7. Germination:

In order to have good germination of vegetables, a good bed should be made for the seeds before placing in the soil by leveling the soil surface as much as possible to avoid washing away the roots by irrigation. It is preferable to plant seeds or seedlings (after raising in the nursery), depending on the type of plant, in two rows at both sides of the water pipe (drip irrigation). The distance between each hole and the other varies according to the type of crop planted, in general, the average the distance ranges between each row and the other from 40 to 50 cm. Seeds are placed in holes approximately 1 to 3 seeds (according to the germination rate and the farmers experience).

8. Plastic Covering:

Very important throughout the plant growth period until harvest time. This cover is not removed off the seedlings except only during working time (irrigation, harvest time, etc.) and this must be during the morning period from 6 to 9 a.m. only. The cover must be loose and not compressed over the plants.

The application of this invention was carried out for the first time by the Company in Egypt and the Middle East after having conducted several field tests at different sites in the Arab Republic of Egypt under different climatic conditions and the invention proved to be successful. Therefore, the “Bio-Super Vegetable Gardens (BSVG) can be considered a new environmental and agricultural innovation that aims at increasing the benefits of the unit area for the production of several varieties of organic vegetables of high quality and quantity. BSVG promises a healthy and wealthy future for the whole world, particularly the Arab region. The research results which took more than two years at different environment locations in the Arab Republic of Egypt were compiled.

### BRIEF DISCLOSURE OF DRAWING

Diagram (1): lay out of a “Garden” consisting of 4 plots:

1. Source of irrigation water;

2. Security hedge;

3. Wind break shrub

4. Access path between gardens (0.8 m)

5. Cultivated plot (1.2×12.5 m)

6. Drippers pipe;

7. 0.6 m-wide paths between plots;

8. lm.-wide principal access path.

Diagram (2): Steps for preparing plot includes: (a) extraction of soil from the entire circumference (20 cm. wide and 45 cm. deep; (b) placing black PVC plastic sheets and making a hole in the plot center for laying the drain pipe and rice straw; (c) refilling the hole with soil and adding organic vegetable fertilizer, bentonite or biochar, a mixture of beneficial natural minerals, bio-polymer and microorganisms (EM) and, then, laying the water and irrigation pipes.

1. Extraction of soil from all sides (20 cm. wide and 45 cm. deep);

2. Sandy soil;

3. Float stick;

4. Black PVC plastic sheet;

5. Rice straw;

6. Drainage pipe;

7. Gravels;

8. Vegetable seedlings;

9. Compost;

10. Organic fertilizer;

11. Bentonite or biochar;

12. Mixture of natural minerals;

13. Bio-polymer;

14. Efficient Microorganisms (EM);

15. Dripper pipe.

1. A Bio-Super Vegetable Garden (BSVG) comprising soil and an added combination of organic fertilizers, bentonite, biochar, a mixture of natural minerals, efficient microorganism (EM), and bio-polymer, said combination providing the soil with optimum natural, chemical and biological conditions to increase productivity of the soil.

2. The BSVG according to claim 1, wherein the organic fertilizers are a combination of plant waste and animal waste high in nutrition value.

3. The BSVG according to claim 1, wherein the bentonite is a natural alluvium mineral found abundantly in the form of clay all over the Arab Republic of Egypt and has the ability to increases water and nutrition retention of sandy soil.

4. The BSVG according to claim 1, wherein the biochar is a plant biomass processed under high temperature and reducing conditions and has the ability to increase retention capability of water and necessary nutrition elements in sandy soil.

5. The BSVG according to claim 1, wherein the natural minerals mixture is a combination of natural minerals capable of providing plants with all the necessary major and minor nutritional elements.

6. The BSVG according to claim 1, wherein the EM is a combination of micro organic matter that comprises photosynthesis bacteria, lactic acid bacteria, some yeasts, decomposed molasses.

7. The BSVG according to claim 1, wherein the bio-polymer is a combination of plant waste and animal waste, soluble in water and can be used in organic agriculture.

8. The BSVG according to claim 1, wherein the soil is sandy soil.

9. The BSVG according to claim 2, wherein the plant waste is at least one of compost and rice straw.

10. The BSVG according to claim 2, wherein the animal waste is chicken manure.

11. The BSVG according to claim 7, wherein the animal waste of the biopolymer is gelatin.
